(19) United States
(12) Patent Application Publication
(10) Pub. No.: US 2009/0133281 A1
(43) Pub. Date: May 28, 2009

(54) STEAM LAUNDRY DRYER

(75) Inventors: Ju Han YOON, Changwon-si (KR); Sang Hun BAE, Changwon-si (KR); Seon II HEO, Changwon-si (KR); Yeon Sik CHOI, Changwon-si (KR); Sang Jin KIM, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/272,572

(22) Filed: Nov. 17, 2008

(30) Foreign Application Priority Data
Nov. 16, 2007 (KR) 10-2007-0117172
Jan. 3, 2008 (KR) 10-2008-0000782

(51) Int. Cl. F26B 21/00; D06F 58/02

(52) U.S. Cl. 34/72; 34/108

(57) ABSTRACT

The present invention is related to a steam laundry dryer which may include a steam generator. An embodiment of a laundry dryer according to the present invention comprises a water guard plate having a predetermined-sized surface to block water leaked and flying over from the steam generator or the water supply hose to at least a portion of the control panel.

### CROSS-REFERENCE TO RELATED APPLICATION

This application claims the benefit of Korean Patent Application Nos. 10-2007-117172 and 10-2008-000782, filed on Nov. 16, 2007 and Jan. 3, 2008, respectively, which are hereby incorporated by reference in their entireties as if fully set forth herein.

### BACKGROUND OF THE INVENTION

1. Field of the Invention

The present invention is related to a steam dryer which may be for drying especially laundry. The steam dryer may include a steam generator.

2. Discussion of the Related Art

A dryer may be a home appliance that dries wet laundry using high-temperature air. Generally, the dryer includes a drum for receiving laundry to be dried, a drive source for driving the drum, a heating unit for heating air to be introduced into the drum, and a blower unit for suctioning or discharging air into or out of the drum.

Based on how air is heated, i.e., the type of the heating unit, the dryer may be classified as an electric dryer or a gas dryer. The electric dryer typically heats air using electric resistance heaters, whereas the gas dryer typically heats air using heat generated by the combustion of gas.

In addition, the dryer may be classified as a condensation type dryer or an exhaust type dryer. In the condensation type dryer, air, heat-exchanged with clothes to be dried in a drum and changed into a high-humidity phase, is circulated without discharging the air out of the dryer. Heat exchange is performed between an additional condenser and external air to produce condensed water, which is discharged out of the dryer. In the exhaust type dryer, air, heat-exchanged with clothes to be dried in a drum and changed into a high-humidity phase, is directly discharged out of the dryer. Based on how laundry is placed in the dryer, the dryer may be classified as a top-loading type dryer or a front-loading type dryer. In the top-loading type dryer, laundry to be dried is loaded from the top of the dryer. In the front-loading type dryer, laundry to be dried is loaded from the front of the dryer.

### SUMMARY OF THE INVENTION

An embodiment of a laundry dryer according to the present invention comprises a drum in which laundry is to be placed; a steam generator to generate steam; a water supply hose connected to the steam generator to supply water to the steam generator; a control panel configured to allow a user to input commands for operating the laundry dryer; and a water guard plate having a predetermined-sized surface to block water leaked and flying over from the steam generator or the water supply hose to at least a portion of the control panel.

The water guard plate is configured or arranged such that the predetermined-sized surface is placed apart from the at least a portion of the control panel. If water guard plate is arranged close to the control panel, it is liable that water flows along a surface of the water guard plate and reaches the control panel.

If electrical components in the dryer are wet, electricity may be leaked out and cause a safety problem. Especially, the control panel is an electrical component for interfacing with a user. Normally, users touch the control panel with bare hands. Therefore, if the control panel is wet, it is highly liable that the user gets an electric shock by the leaked electricity. It is well understood that water may also damage an electrical component.

Unlike the conventional laundry dryer, the dryer according to the present invention comprises a steam generator which needs to be supplied with water. The steam generator may be connected by a water supply hose to be supplied with water from a water source such as a tap (faucet) or a water container. The steam generator may be directly connected to the tap or may be connected to a water container which is provided in the dryer to contain water for the supplying of water to the steam generator.

In a service time of the dryer, water supply line for the water supplying may be broken and water may be leaked. Since water is under high pressure at the initial stage of the breakage, the leaked water is jetted and reaches far. Therefore, even the steam generator or the water supply line is arranged as apart as possible from the electrical component, the leaked water may fly over and reach the electrical component.

The dryer according to the present invention comprises a water guard plate to block the leaked water and prevent the water from reaching an electrical component. Especially, the water guard plate is arranged to shield the control panel form the leaked water.

Further, the control panel may comprise an electrical-component interface portion which is exposed for being connected to an electrical component inside the dryer. The control panel may be connected to an electrical component such as a motor, which is for rotating the drum, or a heater which is for heating air to be supplied into the drum. For the connections, the control panel may comprise the electrical-component interface portion, and the electrical-component interface portion is arranged exposed.

The water guard plate is configured or arranged especially for protecting the exposed electrical-component interface portion from the leaked water.

The size of the predetermined-sized surface of the water guard plate may be determined after considering which to be protected, especially which portion of the water supply line to be blocked, and where to place the water guard, etc.

The steam generator may be arranged at one portion of right and left portions in the dryer and the electrical-component interface portion is arranged at the other portion.

For instance, the steam generator may be arranged at the left portion and the electrical-component interface portion is arranged at the right portion.

It is preferable that the steam generator and the electrical-component interface portion are arranged as apart as possible from each other.

For compact arrangements of the components in the dryer, a portion of the steam generator to be connected to the water supply hose may face the direction where the electrical-component interface portion is placed. In the above instance, the portion of the steam generator connected to the water supply hose may face right. The portion may comprise a water port which is configured to be connected to the water supply hose.

The steam generator and the control panel may be arranged on an upper portion inside of the dryer. Further, the steam generator may be placed at a rear portion in the dryer. Where a steam nozzle is mounted at a rear portion of the drum, it is preferable that the steam generator is placed as near as possible to the location of the steam nozzle.

The dryer may further comprise a water container to contain water and a pump to pump the water to the steam generator. In the dryer, the pump may be arranged in front of the steam generator and the water container is arranged in front of the pump.

The water container, the pump, and the steam generator may be arranged in a line at a left or right portion inside the dryer. The dryer may further comprise a drawer mounted in a front thereof and the water container may be detachably mounted in the drawer.

A flexible water supply hose may connect between the pump and the steam generator by being bended into a ‘U’ shape. In a compact arrangement of the pump and the steam generator, the distances between each other may be short and the connecting hose may be highly bended. The highly bended hose may worsen the leaking problem of water. However, since the pump and the steam generator are arranged near to each other and the area to cover with the water guard may become smaller, the water guard plate may more effectively block the leaked water.

The water guard plate may be mounted such that it covers the control panel. To the end, the water guard plate may be mounted to the control panel. Further, the water guard plate may be detachably mounted by screws, clips, or the likes so that it can be detached as necessary, especially when a service person provides a service.

The predetermined-sized surface of the water guard plate may be in various shapes. The predetermined-sized surface may be configured to be flat and vertical, or curved.

The water guard plate may comprise a first portion having the predetermined-sized surface; and a second portion extended toward the control panel from the first portion and mounted to the control panel.

Further, the water guard plate may be detachably mounted to a frame which is between the control panel and the steam generator or the water supply hose.

The dryer may have a frame which crosses between the front and the rear in the dryer. The frame may be configured to support the drawer. The water guard plate may be mounted on the frame.

Alternatively, the water guard plate may be mounted to a top cover of the laundry dryer. Further, the water guard plate may be formed as one body with the top cover.

Furthermore, the water guard plate may be formed as to be flexible. The water guard plate may be formed of flexible plastic. The flexible water guard may minimize interference with assembly works for other components.

In another embodiment, the water guard plate may be attached by bonding material. The water guard plate may have a bonding portion on which the bonding material is already attached on. The attachment of the water guard plate can be easily performed by attaching the bonding portion to the mounting place in the dryer.

A laundry dryer of another embodiment according to the present invention may comprise a drum in which laundry is to be placed; a water container to contain water, the water container accessible from outside to supply water therein; a steam generator to generate steam; a pump to pump water from the water container to the steam generator; a water supply hose to connect between the steam generator and the pump; a control panel configured to allow a user to input commands for operating the laundry dryer, the control panel having an electrical element which is exposed inside the dryer for interfacing with an electrical component in the laundry dryer; and a wall to block water leaked and flying over from the steam generator or the water supply hose to the electrical element, the wall configured to block the water at a predetermined distance from the electrical element.

In addition, a laundry dryer of another embodiment according to the present invention may comprise a drum in which laundry is to be placed; a steam generator to generate steam, the steam generator having a water port; a water supply hose connected to the water port of the steam generator; an electrical component mounted inside the dryer, the electrical component arranged around the steam generator; and a water guard plate having a predetermined-sized surface and arranged at a predetermined distance from the electrical component to block water leaked and flying over from the water port to the electrical component.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In addition, it is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a first embodiment of a laundry dryer according to the present invention;

FIG. 2 shows a sectional view of the dryer shown in FIG. 1;

FIG. 3 shows a second embodiment of a laundry dryer according to the present invention; and

FIG. 4 shows a third embodiment of a laundry dryer according to the present invention.

FIG. 5 shows a third embodiment of a laundry dryer according to the present invention.

FIG. 6 shows a third embodiment of a laundry dryer according to the present invention.

### DETAILED DESCRIPTION OF THE INVENTION

Reference will now be made in detail to exemplary embodiments of the invention, which are illustrated in the accompanying drawings. Wherever possible, the same reference numbers will be used throughout the drawings to refer to the same or like parts.

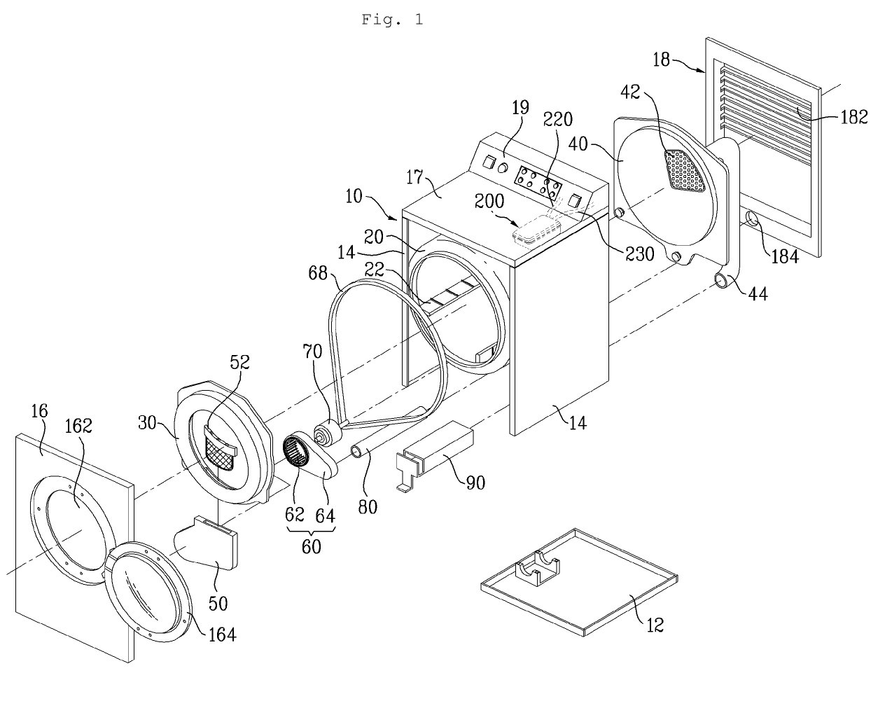

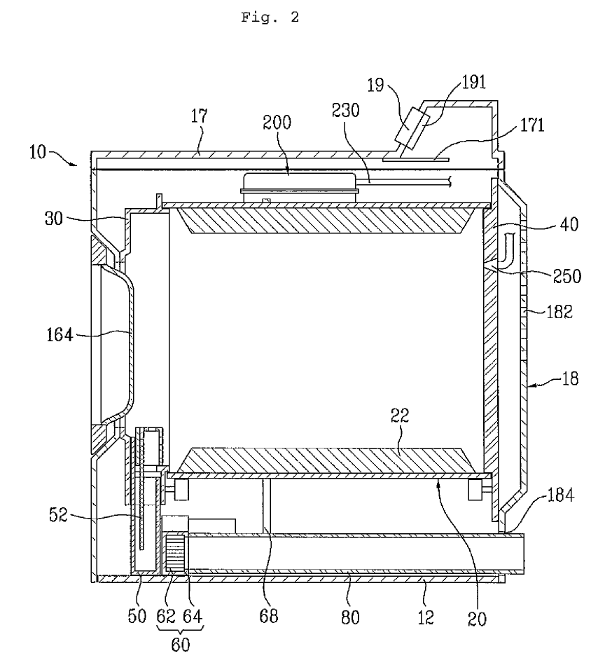

FIGS. 1 and 2 illustrate a dryer having a steam generator.

A cabinet 10 defines an exterior of the dryer. A rotary drum 20, and a motor 70 and a belt 68 for driving the drum 20 are mounted in the cabinet. At predetermined positions, in the cabinet 10, are mounted a heater 90 (hereinafter, referred to as a “hot air heater” for convenience of description) for heating air to generate high-temperature air (hereinafter, referred to as “hot air”), and a hot air supply duct 44 for directing hot air, generated by the hot air heater 90, into the drum 20. In the cabinet 10 are also mounted an exhaust duct 80 for discharging high-humidity air, heat-exchanged with an object to be dried in the drum 20, out of the dryer, and a blower unit 60 for suctioning the high-humidity air. In addition, a steam generator 200, for generating high-temperature steam, is mounted at a predetermined position in the cabinet 10. In this embodiment, an indirect drive system, in which the drum 20 is rotated using the motor 70 and the belt 68, is illustrated and described for convenience of description. However, this disclosure is not limited to the indirect drive system. For example, this disclosure may be applied to a direct drive system in which the motor is directly connected to the rear of the drum 20 such that the drum 20 is directly rotated by the motor.

Now, the respective components of the dryer will be described in detail.

The cabinet 10 defines the exterior of the dryer. The cabinet 10 includes a base 12 constituting the bottom thereof, a pair of side covers 14 mounted vertically on respective sides of the base 12, a front cover 16 and a rear cover 18 mounted at the front and rear of the side covers 14, respectively, and a top cover 17 located at the top of the side covers 14. A control panel 19, having various manipulation switches, is normally disposed at the top cover 17 or the front cover 16. The front cover 16 includes an opening 162. A door 164 is mounted to the front cover 16. The rear cover 18 is provided with a suction unit 182, through which external air is introduced, and an exhaust hole 184, which is a final channel for discharging the interior air of the drum 20 outside.

The interior space of the drum 20 serves as a drying chamber in which a drying process is carried out. Inside the drum 20 are preferably mounted lifts 22 for lifting and dropping clothes to be dried, such that the clothes turn over, to increase drying efficiency.

A front supporter 30 and a rear supporter 40 are mounted between the drum 20 and the cabinet 10, i.e., between the drum 20 and the front cover 16 and between the drum 20 and the rear cover 18, respectively. The drum 20 is rotatably mounted between the front supporter 30 and the rear supporter 40. Between the front supporter 30 and the drum 20 and between the rear supporter 40 and the drum 20 are mounted sealing members (not shown) for preventing the leakage of air, respectively. Specifically, the front supporter 30 and the rear supporter 40 enclose the front and the rear of the drum 20 to define the drying chamber. Also, the front supporter 30 and the rear supporter 40 serve to support the front end and the rear end of the drum 20, respectively.

In the front supporter 30 is formed an opening, through which the drum 20 communicates with the outside of the dryer. The opening is selectively opened and closed by the door 164. A lint duct 50, which is a channel for discharging the interior air of the drum 20 outside, is connected to the front supporter 30. A lint filter 52 may be mounted in the lint duct 50. One side of the blower unit 60 is connected to the lint duct 50, and the other side of the blower unit 60 is connected to the exhaust duct 80. The exhaust duct 80 communicates with the exhaust hole 184, which is formed in the rear cover 18. When the blower unit 60 is operated, the interior air of the drum 20 is discharged outside through the lint duct 50, the exhaust duct 80, and the exhaust hole 184. At this time, foreign matter, such as lint, may be filtered out by the lint filter 52. Generally, the blower unit 60 includes a blower 62 and a blower housing 64. The blower 62 is generally connected to the motor 70, which drives the drum 20. Consequently, the blower unit 60 and the drum 20 are simultaneously driven during the operation of the motor 70. Of course, the blower unit 60 and the drum 20 may be constructed to be separately driven. If this is the case, then two motors may be connected to the blower unit 60 and the drum 20, respectively.

The rear supporter 40 includes an opening 42 and a plurality of through-holes. The hot air supply duct 44 is connected to the opening 42. The hot air supply duct 44, communicating with the drum 20, serves as a channel for supplying hot air into the drum 20. The hot air heater 90 is mounted at a predetermined position on the hot air supply duct 44.

The steam generator 200, for generating steam to be supplied into the drum 20, is mounted at a predetermined position within the cabinet 10.

The steam generator 200 may include a water tank for holding water, a heater placed inside the water tank, a water level sensor for measuring a water level of the steam generator 200, and a temperature sensor for measuring a temperature of the steam generator 200.

In general, the water level sensor may include a common electrode, a low water level electrode, and a high water level electrode for sensing a high water level by electric conduction between the common electrode and the high water level electrode or a low water level by electric conduction between the common electrode and the low water level electrode.

A water supply hose 220 is connected a water port of the steam generator 200 to supply water to the steam generator. Also, a steam hose 230 is connected to a steam port of the steam generator 200 to supply the steam generated in the steam generator 200 to the drum 20. As shown in FIG. 2, the steam hose 230 is provided with a nozzle 250 at a fore end of the steam hose 230. The nozzle 250 may be in a predetermined shape.

The water supply hose 220 may be connected to an external water supply source, such as tap or a water container containing water.

The nozzle 250 is located at such a predetermined location that steam can be sprayed an inside of the drum 20.

Though, in the above described embodiment, the steam generator 200 is a so called “tank type steam generator” in which an amount of water held in the water tank of a predetermined size is heated with a heater to generate the steam, the present invention is not limited to this. That is, the present invention can use any type steam generator as far as the device can generate the steam. For an example, a so called “tubular type steam generator” may also be used. In the tubular type steam generator, water is supplied into a steam generating zone and rapidly heated to be converted to steam. The flow rate of the water supplied into the steam generating zone may be controlled. For the sake, a pump or a valve connected between the steam generating zone and an outer water supply source may be controlled by a controller.

The control panel 19 has an electrical-component interface portion 191 which is exposed for the connections to other electrical components, such as the motor 70 or the electrical heater 90.

The control panel 19 is mounted in an upper portion of the dryer and the steam generator 200 is placed in the vicinity of the control panel 19.

In this embodiment, there is provided a water guard plate 171 between the water supply hose 220 and the electrical-component interface portion 191 of the control panel. The water guard plate 171 blocks water leaked and fling over from the water supply hose 220 to the electrical-component interface portion 191.

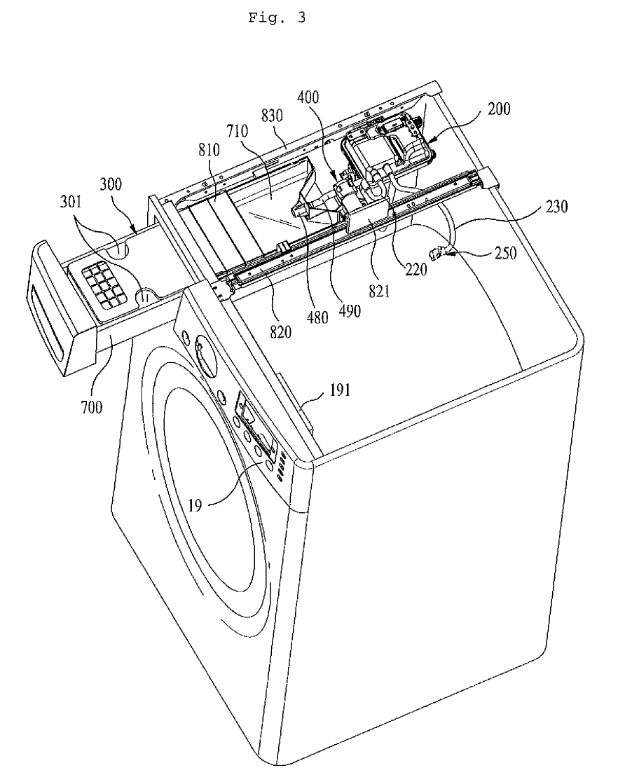

FIG. 3 shows another embodiment.

In this embodiment, the dryer has a drawer 700, a water container 300 (hereinafter, the water container is called as a cartridge simply for the sake of convenience for describing), and a pump 400.

The drawer 700 is provided to the front of the dryer together with the control panel 19. The drawer 700 is mounted such that it can be slid back and forth.

In detail, a supporter 820 is provided inside of the dryer as parallel to the top frame 830 substantially, and a drawer guide 710 is mounted to the supporter 820 and the top frame 830 for guiding and supporting the drawer 700, and a top guide 810 is provided to a portion of an upper portion of the drawer guide 710.

The drawer guide 710 has opened upper portion and one side (on a front side of the dryer), so that the drawer 700 is pushed in/pulled out through the opened one side, and a connection port 480 is provided to an upper portion of the other side of the drawer guide 710.

The cartridge 300 is detachably mounted in the drawer 700.

The pump 400 is for pumping the water in the cartridge 300 to the steam generator 200. The pump 400 is connected to a water port of the steam generator via a water supply hose 220. Further, the pump 400 is connected to the connection port 480 via a hose 490. The connection port 480 is configured to be connectable to the cartridge 300 when the draw 700 is pushed in.

A method for supplying water to the cartridge 300 will be described.

When the user pulls out the drawer 700, the cartridge 300 is also pulled out. In this state, the cartridge 300 is dismounted from the drawer 700, and water is supplied to the cartridge 300 dismounted. The cartridge 300 having the water filled therein is mounted to the drawer 700 again, and then, if the drawer 700 is pushed in, the cartridge 300 and the connection port 480 are connected accordingly.

In this embodiment, the steam generator 200 is placed at a rear left corner inside of the dryer. The location of the steam generator 200 may be determined such that the path of the steam from the steam generator 200 to the nozzle 250 is short. In this embodiment, the steam nozzle 250 is placed at a rear portion inside of the dryer, so the steam generator 200 is placed as such.

Further, the steam generator 200 is arranged such that a water port and a steam port, which are connected to the water supply hose 220 and the steam hose 230, respectively, face right.

In regards to the control panel 19, it is mounted at a front portion of the dryer. In addition, the electrical component interface portion 191 of the control panel 19 is placed at a front right portion inside of the dryer.

The steam generator 200 and the control panel 19 are placed at an upper portion of the dryer. In the embodiment, both are placed at an almost same level of height.

Since the steam generator 200 is placed at a rear left portion and the electrical-component interface portion 191 is place at an front right portion, leaked water from the steam generator 200 or the water supply hose 220, especially from the connection between the steam generator 200 and the water supply hose 220, is prevented from reaching the electrical-component interface portion 191 to an extent. However, since water is in a pressurized state in the initial stage of the leaking, the arrangements may be insufficient to block the leaked water.

For the reason, there is provided with a water guard plate 821. Especially, the water guard plate 821 is mounted to block between the portion of the steam generator 200 via which the water supply hose 220 is connected to the steam generator 200 and the electrical-component interface portion 191 of the control panel 19. The water guard plate 821 blocks a predetermined path of the leaked water from the portion of the steam generator 200 to the electrical-component interface portion 191 of the control panel 191.

Further, the water guard plate 821 is large enough to block water leaked from the connection between the pump 400 and the water supply hose 220. In this embodiment, the distance between the pump 400 and the steam generator 200 is relatively short. To connect between the pump 400 and the steam generator 200 within a short distance, the water supply hose 220 is highly bended. The more highly bended water supply hose 220 may induce the larger possibility of leakage of water. In the case that the water supply hose 220 is highly bended, the water guard plate 821 is more highly required to be provided to block the leaked water.

Water may also be leaked through the connection between the steam generator 200 and the steam hose 230. For the reason, the water guard plate 821 is configured to further cover a predetermined path between the connection and the electrical-component interface portion 191.

The steam hose 230 may have a larger possibility of breakage than the water supply hose 220 has, since the steam hose 230 is repeatedly heated by steam and cooled.

In the dryer shown in FIG. 3, the water guide is mounted on the supporter 820 which is a frame mounted inside the dryer.

The water guard plate 821 may be mounted by screws or by bonding material. The assembling work for the mounting of the water guard plate 821 is easily performed.

Alternatively, the water guard plate 821 may be formed as one body with the supporter 820.

The water guard plate 821 may be formed of plastic. Further, the water guard plate 821 may be configured to be flexible to be easily bended.

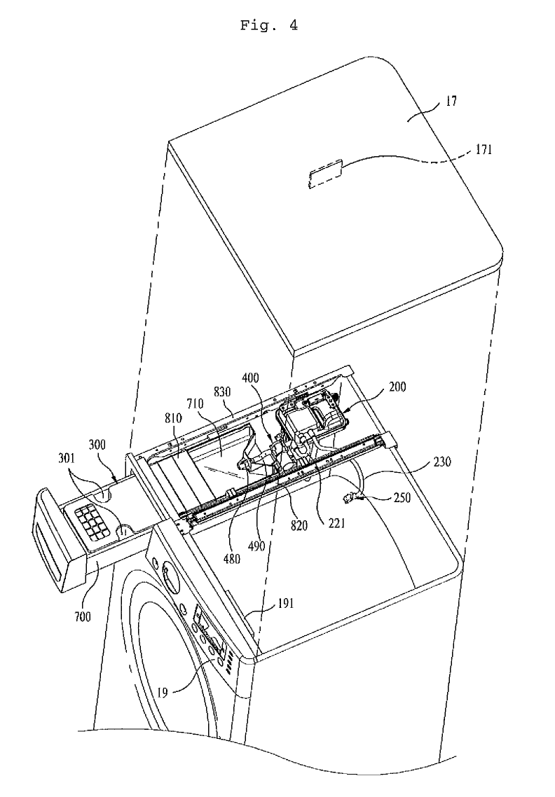

The FIG. 4 shows another embodiment of a dryer according to the present invention.

As shown in FIG. 4, in this embodiment, a water guard plate 171 is mounted to the top cover 17. Likewise, the water guard plate 171 is mounted in the same method as in the dryer of the FIG. 3. Namely, the water guard plate 171 may be mounted to the top cover 17 by screws or by bonding material, or formed as one body with the top cover 17. In addition, the water guard plate 171 may be formed of plastic, and further to be flexible.

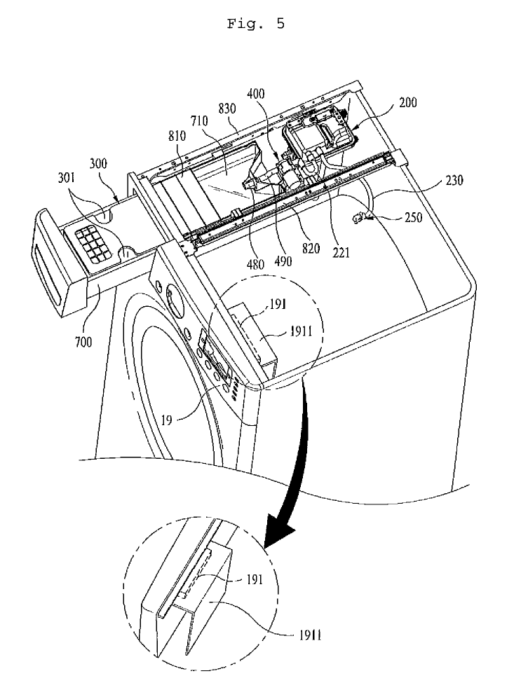

The FIG. 5 shows another embodiment of a dryer according to the present invention.

In this embodiment, a water guard plate 1911 is mounted to cover the electrical-component interface portion 191. The water guard plate 1911 may be mounted on the front cover or a rear surface of the control panel 19.

The water guard plate 1911 is configured to have a predetermined-sized plate and a portion extending from the plate. The predetermined-sized plate is to block the water leaked and flying over to the electrical-component interface portion 191 of the control panel 19, and the portion extending from the predetermined-sized plate is for the mounting of the water guard plate 1911 in the dryer.

The water guard plate 1911 is configured to keep the predetermined-sized plate at a distance from the electrical-component interface portion 191. If the predetermined-sized plate is too close to the electrical-component interface portion 191, water reaching the plate may reach the electrical-component interface portion 191 behind the plate by flowing along the water guard plate.

In this embodiment, the way of mounting of the water guard plate 1911 is the same as the previously described embodiments. Further, the water guard plate 1911 may be formed of plastic, and further to be flexible.

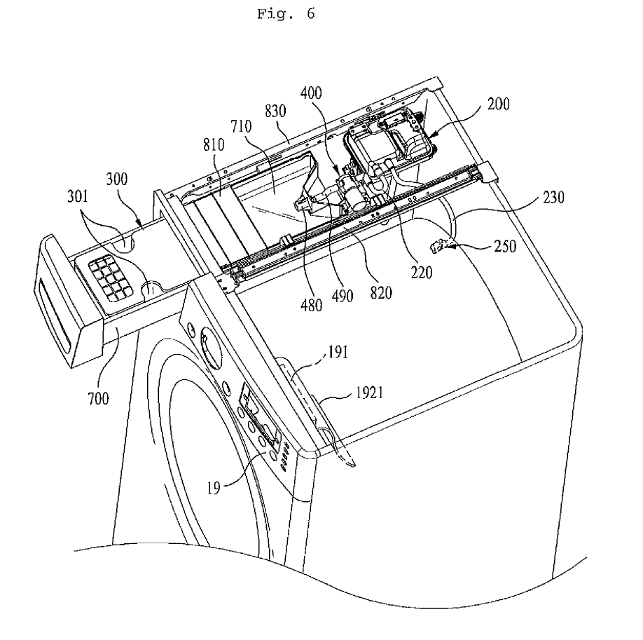

FIG. 6 shows another embodiment. In this embodiment, the water guard plate 1921 is different in shape from the water guard plate 1911 in FIG. 5.

The water guard plate 1921 is mounted to the dryer at an end and is formed as outwardly bended at the other end. In addition, the extended portion of the water guard plate 1921 is formed in a curved shape. The water guard plate 1921 is formed in a shape to effectively detour water away form the electrical-component interface portion 191.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry dryer comprising:
a drum in which laundry is to be placed;
a steam generator to generate steam;
a water supply hose connected to the steam generator to supply water to the steam generator;
a control panel configured to allow a user to input commands for operating the laundry dryer; and
a water guard plate having a predetermined-sized surface to block water leaked and flying over from the steam generator or the water supply hose to at least a portion of the control panel, the water guard plate configured such that the predetermined-sized surface is placed apart from the at least a portion of the control panel.

2. The laundry dryer of claim 1, wherein the at least a portion of the control panel comprises an electrical-component interface portion which is exposed for being connected to an electrical component.

3. The laundry dryer of claim 2, wherein the electrical component comprises a motor for rotating the drum or a heater.

4. The laundry dryer of claim 1, wherein the steam generator is arranged at one portion of right and left portions in the dryer and the electrical-component interface portion is arranged at the other portion.

5. The laundry dryer of claim 4, wherein the steam generator is arranged at a rear left portion in the dryer and the electrical-component interface portion is arranged at a front right portion in the dryer.

6. The laundry dryer of claim 5, wherein the steam generator is arranged such that a portion connected to the water supply hose face right.

7. The laundry dryer of claim 4, further comprising a water container to contain water and a pump to pump the water to the steam generator, wherein the pump is arranged in front of the steam generator and the water container is arranged in front of the pump.

8. The laundry dryer of claim 7, wherein the water supply hose is formed as flexible and connects between the plate is mounted to the control panel.

9. The laundry dryer of claim 1, wherein the water guard plate is mounted to the control panel.

10. The laundry dryer of claim 9, wherein the predetermined-sized surface is configured to be flat and vertical.

11. The laundry dryer of claim 10, wherein the predetermined-sized surface is configured to be curved.

12. The laundry dryer of claim 9, wherein the water guard plate is detachably mounted to the control panel.

13. The laundry dryer of claim 1, wherein the water guard plate comprises:
a first portion having the predetermined-sized surface; and
a second portion extended toward the control panel from the first portion and mounted to the control panel.

14. The laundry dryer of claim 1, wherein the water guard plate is configured to be a flat vertical plate.

15. The laundry dryer of claim 14, wherein the water guard plate is detachably mounted to a frame which is between the control panel and the steam generator or the water supply hose.

16. The laundry dryer of claim 14, wherein the water guard plate is mounted to a top cover of the laundry dryer.

17. The laundry dryer of claim 15, wherein the water guard plate is formed as one body with the top cover.

18. The laundry dryer of claim 1, wherein the water guard plate is formed of flexible plastic.

19. The laundry dryer of claim 18, wherein the water guard plate is attached by bonding material to a frame which is between the control panel and the steam generator or the water supply hose.

20. A laundry dryer comprising:
a drum in which laundry is to be placed;
a water container to contain water, the water container accessible from outside to supply water therein;
a steam generator to generate steam;
a pump to pump water from the water container to the steam generator;
a water supply hose to connect between the steam generator and the pump;
a control panel configured to allow a user to input commands for operating the laundry dryer, the control panel having an electrical element which is exposed inside the dryer for interfacing with an electrical component in the laundry dryer; and
a wall to block water leaked and flying over from the steam generator or the water supply hose to the electrical element, the wall configured to block the water at a predetermined distance from the electrical element.

21. A laundry dryer comprising:
a drum in which laundry is to be placed;
a steam generator to generate steam, the steam generator having a water port;
a water supply hose connected to the water port of the steam generator;
an electrical component mounted inside the dryer, the electrical component arranged around the steam generator; and
a water guard having a predetermined-sized surface and arranged at a predetermined distance from the electrical component to block water leaked and flying over from the water port to the electrical component.
